(19) United States
(12) Patent Application Publication
(10) Pub. No.: US 2003/0113088 A1
(43) Pub. Date: Jun. 19, 2003

(54) Optical fiber positioning element at optical fiber bundling part in optical fiber type display and method of manufacture and optical fiber type display

(76) Inventors: Norimitsu Takeya, Chiba (JP); Hiroshi Higashida, Chiba (JP)

Correspondence Address: WENDEROTH, LIND & PONACK, L.L.P., 2033 K STREET N. W., SUITE 800, WASHINGTON, DC, 20006-1021, US

(21) Appl. No.: 10/343,737

(22) PCT Filed: Jun. 29, 2001
(86) PCT No.: PCT/JP01/05642

(30) Foreign Application Priority Data
Aug. 3, 2000 (JP) 2000-235966

(51) Int. Cl. G02B 6/00

(52) U.S. Cl. 385/136; 385/137; 385/901

(57) ABSTRACT

The present invention provides an optical fiber positioning element (8) of an optical fiber converging portion (3) for converging a large number of optical fibers (5) led to a screen panel (4) for image display in an optical fiber display system. The optical fiber positioning element (8) comprises a belt-shaped body (9) and a plurality of optical fiber supports (10) provided on the upper and lower sides of the belt-shaped body (9) at a predetermined pitch in the longitudinal direction of the belt-shaped body. The optical fibers (5) are supported by engagement with a plurality of optical fiber supports (10) on the upper and lower sides of the belt-shaped body.

In addition, the present invention provides an optical fiber display system wherein an image projected onto an optical fiber converging portion from a projector is guided to a screen panel (24) through a large number of optical fibers (25) converged at the optical fiber converging portion to display the image on the screen panel (24). In the optical fiber display system, a plurality of projectors (27a to 27d) are provided, and the optical fiber converging portion (28) comprises a plurality of converging units (28a to 28d) connected to each other. Images projected onto the plurality of converging units (28a to 28d) from the plurality of projectors (27a to 27d) individually are superimposed on one another on the screen panel (24) so as to be displayed as a single image.

### FIELD OF INDUSTRIAL APPLICATION

The present invention relates to an optical fiber positioning element constituting an optical fiber converging portion for converging a large number of optical fibers led to a screen panel for image display in an optical fiber display system. The present invention also relates to a method of producing the optical fiber positioning element. Further, the present invention relates to an optical fiber display system using the optical fiber positioning element.

### BACKGROUND ART

In general, large-sized image display systems are arranged, by way of example, as follows. A large number of light-emitting components, e.g. light bulbs or light-emitting diodes, are arranged on a screen panel of a display system in a matrix of a plurality of rows (or tiers) and a plurality of columns, and these light bulbs or light-emitting diodes are turned on and off under control with a composite switching mechanism, thereby displaying an image. However, this type of display system suffers from some problems. Because there is a limitation to the switching speed of the switching mechanism, the display system is inadequate to display moving video pictures with high image changing speed. In addition, light bulbs burn out easily and hence need to be replaced frequently, thus requiring troublesome maintenance. Light-emitting diodes are longer in lifetime than light bulbs. However, when one light-emitting diode has burned out, a unit comprising some light-emitting diodes including the one that is out of order needs to be replaced in its entirety. Thus, maintenance is similarly troublesome.

Another example is an optical fiber display system 1 as shown in FIG. 1. The system 1 comprises roughly a projector 2, an optical fiber converging portion 3, a screen panel 4, and a large number of optical fibers 5 connecting the converging portion 3 and the screen panel 4 to each other. A video signal from a video player unit 6 is sent to the projector 2. An image from the projector 2 is projected on the optical fiber converging portion 3. The image projected on the optical fiber converging portion 3 is guided to the screen panel 4 through the large number of optical fibers 5 stretched between the optical fiber converging portion 3 and the screen panel 4 in a plurality of tiers (rows) and a plurality of columns. Consequently, light is emitted from the optical fiber output ends on the front side of the screen panel 4 to display the desired image. This arrangement need not place any light-emitting components on the screen panel. Therefore, the above-described problems can be solved.

In general, there are two methods of stacking a large number of optical fibers in the above-described optical fiber converging portion: a method wherein optical fibers are stacked in a staggered fashion as shown in FIG. 2; and another method wherein optical fibers are stacked regularly as shown in FIG. 3. However, these stacking methods involve the following problems:

\mathring{1} With the staggered stacking method, the axis position of optical fibers 5 in a given row and that of optical fibers 5 in the row right above it are displaced from each other horizontally by a distance substantially corresponding to the radius of the optical fibers 5. Incidentally, pixels of a liquid crystal panel (not shown) in the projector 2 are arranged regularly in such a manner that rows and columns connecting the pixel centers each extend in a straight-line form. Therefore, precisely speaking, the image at the liquid crystal panel and the image at the optical fiber converging portion 3 are undesirably displaced from each other horizontally between the rows of optical fibers by an amount corresponding to the radius of the optical fibers. Accordingly, it is impossible to display an accurate image.

\mathring{2} In the case of the regular stacking method, the problem associated with the staggered stacking method can be solved. However, each optical fiber 5 in a given row contacts an optical fiber 5 in the row right above it at only one point in the circumferential direction. In other words, each optical fiber 5 rests on another in such an unstable state that the two optical fibers 5 are in point contact with each other as viewed in the optical fiber cross-section. Therefore, the optical fibers in the upper rows are likely to shift leftward or rightward. Consequently, the same problem as in the staggered stacking method may occur.

### OBJECTS OF THE PRESENT INVENTION

Objects of the present invention are as follows.

\mathring{1} According to the optical fiber positioning element of the present invention, a large number of optical fibers are positioned by being supported at the upper and lower sides thereof with optical fiber supports provided on the upper and lower sides of a belt-shaped body constituting the optical fiber positioning element, thereby increasing the positioning accuracy during assembling of the optical fibers and facilitating the assembling operation.

\mathring{2} Therefore, according to the optical fiber positioning element of the present invention, when a plurality of tiers (rows) of optical fibers are stacked regularly, the optical fibers in the upper and lower adjacent tiers are restrained by the optical fiber positioning element and hence unlikely to be displaced from each other.

\mathring{3} According to the optical fiber display system of the present invention, the optical fiber converging portion comprises a plurality of optical fiber converging units, and a projector is provided individually for each converging unit. With this arrangement, each projector can be correspondingly reduced in size. Accordingly, it is possible to reduce the projection distance from each projector to the associated converging unit and to attain a reduction in overall size of the system.

### STRUCTURE OF THE PRESENT INVENTION

To attain the above-described objects thereof, the present invention provides an optical fiber positioning element (8) of an optical fiber converging portion (3) for converging a large number of optical fibers (5) led to a screen panel (4) for image display in an optical fiber display system. The optical fiber positioning element (8) comprises a belt-shaped body (9) and a plurality of optical fiber supports (10) provided on the upper and lower sides of the belt-shaped body (9) at a predetermined pitch in the longitudinal direction of the belt-shaped body. The large number of optical fibers (5) are supported by engagement with a plurality of optical fiber supports (10) on the upper and lower sides of the belt-shaped body.

Preferably, the plurality of optical fiber supports (10) form accommodating recesses (10e) for engagingly accommodating optical fibers between each pair of adjacent supports among a plurality of supports (10) integrally formed on the belt-shaped body (9) at a predetermined pitch in the longitudinal direction of the belt-shaped body.

Preferably, the plurality of supports (10) are separate from each other.

Preferably, the plurality of supports (10) are integral with each other.

Preferably, the plurality of supports (10) are provided on both sides in the longitudinal direction of the belt-shaped body (9).

Preferably, the belt-shaped body (9) is a metal sheet, and the supports (10) are integrally formed on the metal sheet from a resin by injection molding.

Preferably, the metal sheet (9) has a plurality of through-holes (9a) provided at a predetermined pitch in the longitudinal direction thereof, and the resin supports (10) extend through the through-holes of the metal sheet to form upper support portions (10a) and lower support portions (10b) on both sides of the metal sheet. The upper support portions (10a) and the lower support portions (10b) are integral with each other, respectively. The upper support portions form upper accommodating recesses (10e) for accommodating optical fibers (5) in a tier above the metal sheet, and the lower support portions form lower accommodating recesses (10e) for accommodating optical fibers in a tier below the metal sheet.

In addition, the present invention provides a method of producing an optical fiber positioning element (8) of an optical fiber converging portion (3) for converging a large number of optical fibers (5) led to a screen panel (4) for image display in an optical fiber display system. In the method, a belt-shaped body (9) is provided, and a plurality of optical fiber supports (10) are formed integrally with the belt-shaped body (9) on the upper and lower sides of the belt-shaped body at a predetermined pitch in the longitudinal direction of the belt-shaped body.

Preferably, the belt-shaped body (9) is a metal sheet (9) having a plurality of through-holes (9a) provided at a predetermined pitch in the longitudinal direction thereof, and the plurality of optical fiber engagement members (10) are injection-molded from a resin so as to extend through the through-holes (9a) of the metal sheet to form upper support portions (10a) and lower support portions (10b) on both sides of the metal sheet. The upper support portions (10a) and the lower support portions (10b) are integral with each other, respectively. The upper support portions (10a) form upper accommodating recesses (10e) for engagingly accommodating optical fibers (5) in a tier above the metal sheet, and the lower support portions (10b) form lower accommodating recesses (10e) for engagingly accommodating optical fibers (5) in a tier below the metal sheet.

In addition, the present invention provides an optical fiber converging portion (3) for use in an optical fiber display system to converge a large number of optical fibers (5) led to a screen panel (4) for image display. The optical fiber converging portion (3) comprises a plurality of tiers of optical fiber positioning elements (8) and a plurality of tiers of optical fibers (5), each tier having a plurality of columns of optical fibers (5). The tiers of optical fiber positioning elements (8) and the tiers of optical fibers (5) are alternately stacked. Each optical fiber positioning element (8) comprises a belt-shaped body (9) and a plurality of optical fiber supports (10) provided on the upper and lower sides of the belt-shaped body (9) at a predetermined pitch in the longitudinal direction of the belt-shaped body. The plurality of columns of optical fibers (5) in each tier are placed in engagement with optical fiber accommodating recesses (10e) of a plurality of optical fiber supports (10) on the upper and lower sides of the belt-shaped body (9).

In addition, the present invention is applied to an optical fiber display system (21) wherein an image projected onto an optical fiber converging portion from a projector is guided to a screen panel (24) through a large number of optical fibers (25) converged at the optical fiber converging portion to display the image on the screen panel (24). According to the present invention, the optical fiber display system is provided with a plurality of projectors (27a to 27d). The optical fiber converging portion (28) comprises a plurality of converging units (28a to 28d) connected to each other. Images projected onto the plurality of converging units (28a to 28d) from the plurality of projectors (27a to 27d) individually are superimposed on one another on the screen panel (24) so as to be displayed as a single image.

Preferably, the plurality of converging units (28a to 28d) are assembled together by being connected to each other vertically or horizontally in one vertical plane.

The present invention offers the following advantageous effects:

\mathring{1} In the optical fiber converging portion, a large number of optical fibers can be positioned at the upper and lower sides thereof with optical fiber supports (optical fiber accommodating recesses) provided on the upper and lower sides of the belt-shaped body constituting the optical fiber positioning element. Accordingly, it is possible to increase the positioning accuracy of the optical fibers and to facilitate the assembling operation.

\mathring{2} In particular, even when a plurality of tiers (rows) of optical fibers are stacked regularly, the optical fibers in the upper and lower adjacent tiers (rows) are restrained by the positioning unit and hence unlikely to be displaced from each other.

\mathring{3} Because the optical fiber supports are provided as optical fiber accommodating recesses formed between adjacent support portions, the optical fibers having a circular sectional configuration can be readily and surely engaged with the optical fiber accommodating recesses. Thus, the structure is stabilized.

\mathring{4} If the optical fiber positioning element is injection-molded from a resin onto the belt-shaped body made of a metal, the production quality is stabilized, and the process is suitable for mass production.

\mathring{5} Because the optical fiber converging portion comprises a plurality of optical fiber converging units and a projector is provided individually for each converging unit, each projector can be correspondingly reduced in size. Accordingly, it is possible to reduce the projection distance from each projector to the associated converging unit and to attain a reduction in overall size of the system.

\mathring{6} Moreover, because the four optical fiber converging units 28a to 28d are each in charge of displaying a complete image, even if any of the projectors fails, the complete image can be displayed continuously by the remaining projectors.

### BRIEF DESCRIPTION OF THE DRAWINGS

FIG. 1 is a perspective view showing the whole arrangement of a conventional optical fiber display system.

FIG. 2 is a diagram showing optical fibers stacked in a general staggered fashion in an optical fiber converging portion of an optical fiber display system.

FIG. 3 is a diagram showing optical fibers stacked in a general regular stacking manner in an optical fiber converging portion of an optical fiber display system.

FIG. 4 is a fragmentary sectional front view showing an essential part of an optical fiber converging portion in an optical fiber display system according to the present invention to explain optical fiber positioning elements of the optical fiber converging portion.

FIG. 5 is a perspective view of an optical fiber positioning element shown in FIG. 4.

FIG. 6 is a plan view of the optical fiber positioning element.

FIG. 7 is a schematic perspective view showing the whole arrangement of a conventional optical fiber display system.

FIG. 8 is a schematic perspective view of the whole arrangement of an optical fiber display system according to the present invention, showing an embodiment of a converging portion in the optical fiber display system.

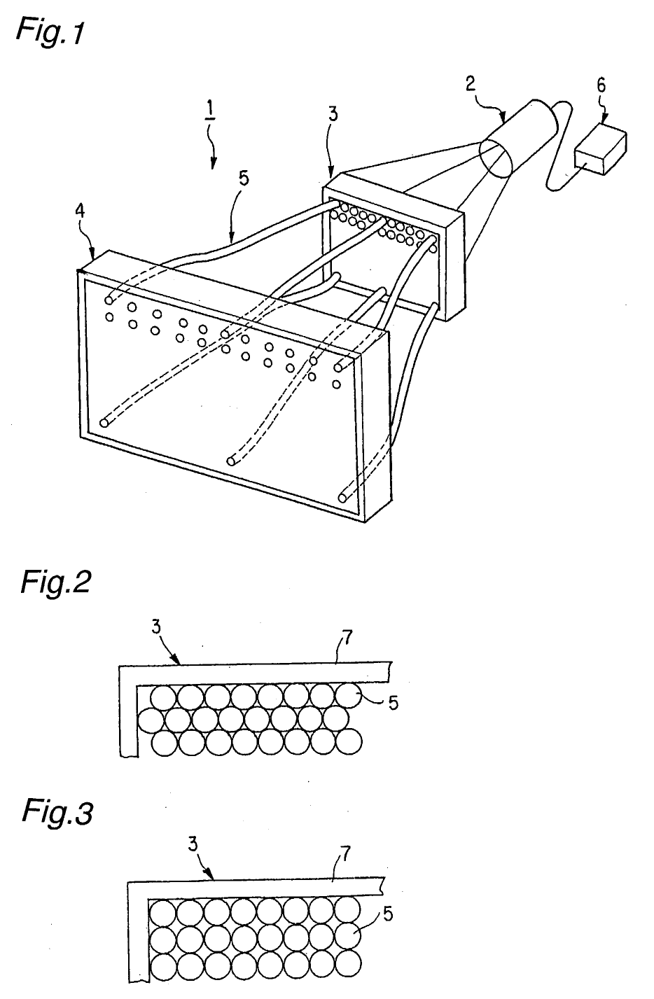

### DESCRIPTION OF PREFERRED EMBODIMENTS

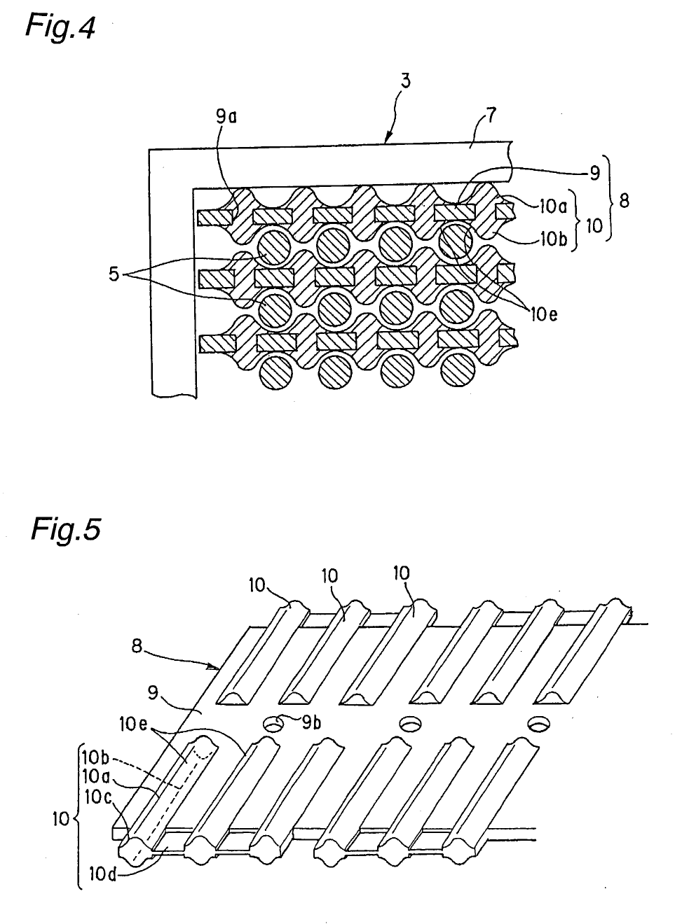

FIG. 4 is a fragmentary sectional front view showing an essential part of an optical fiber converging portion 3 to which the optical fiber positioning element of an optical fiber converging portion in an optical fiber display system according to the present invention is applied. In FIG. 4, the optical fiber converging portion 3 comprises a plurality of tiers (or rows) of belt-shaped spacers 8 (or a plurality of belt-shaped spacers 8) as optical fiber positioning elements and a large number of optical fibers 5 arranged in a matrix of a plurality of tiers each comprising a plurality of columns. The belt-shaped spacers 8 and the optical fibers 5 are alternately stacked in the vertical direction inside a frame 7. The arrangement of the belt-shaped spacers 8 will be described below.

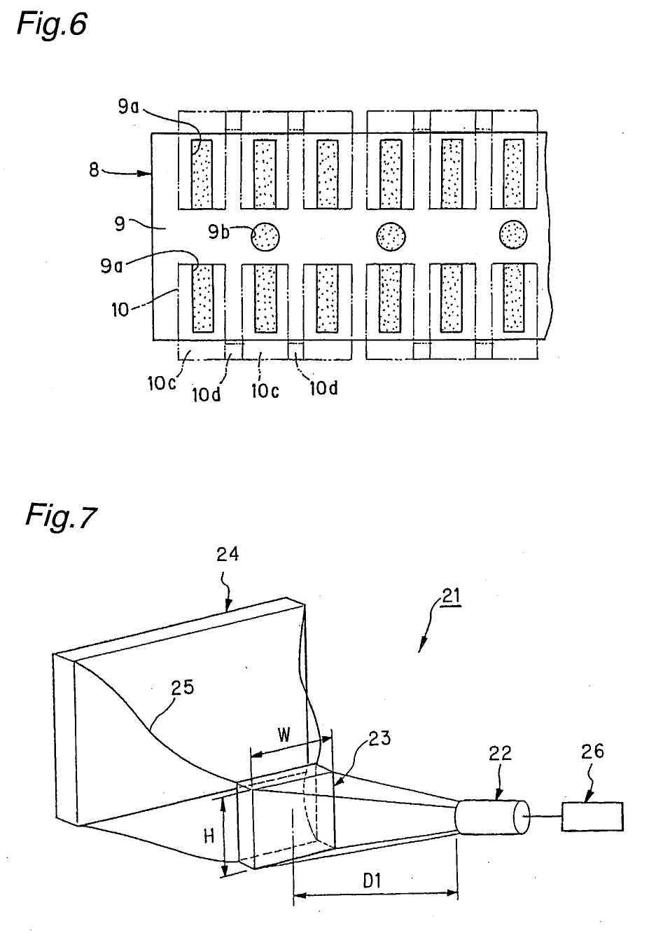

As shown in FIGS. 5 and 6, each belt-shaped spacer 8 comprises a belt-shaped body 9 formed from a metal sheet of stainless steel of nickel silver with a thickness of 0.15 mm, for example, and a plurality of supports 10 of a resin, for example, polypropylene, integrally formed on the belt-shaped body 9 by injection molding process. The belt-shaped body 9 has a plurality of through-slots 9a (shown by pear skin patterns in FIG. 6) provided on both side portions thereof (front and rear end portions in FIG. 5; upper and lower end portions in FIG. 6) to extend in a direction perpendicular to the longitudinal direction at respective positions spaced at a predetermined pitch in the longitudinal direction. The belt-shaped body 9 further has a plurality of feed holes 9b (also shown by pear skin patterns) provided along a center-line between the two side portions so as to be at apositions spaced at a predetermined pitch in the longitudinal direction. The resin supports 10 are integrally formed to extend through the through-slots 9a, respectively, of the belt-shaped body 9 during injection molding process. Each resin support 10 has an upper support portion 10a and a lower support portion 10b, which are integral with each other. The upper and lower support portions 10a and 10b extend in a direction perpendicular to the longitudinal direction. Each resin support 10 further has a connecting projection 10c connecting together the upper and lower support portions 10a and 10b and projecting in a forward or rearward direction. It should be noted that the supports 10 are divided into groups each consisting of three serially adjacent supports 10, and the connecting projection 10c of the supports 10 in each group are integrally joined together through bridge portions 10d, in order to maintain the required strength. It should also be noted that each bridge portion 10d holds a pair of adjacent connecting projections 10c to prevent them from being bent or broken by an external force, which might occur when the connecting projections 10c are not held together but left separate from each other. However, the present invention is not necessarily limited to the described arrangement. The connecting projections 10c may be separate from each other. Alternatively, the arrangement may be such that the supports 10 are divided into groups each consisting of two or more than three (any appropriate number) supports 10, and the connecting projections 10c of the supports 10 in each group are joined together. If necessary, all the connecting projections 10c may be joined together. The arrangement may also be such that each support 10 is integrally joined to another through a bridge portion not at the connecting projection 10c but at at least one of the upper support portion 10a and the lower support portion 10b. Further, in the above-described belt-shaped spacer 8, the belt-shaped body 9 is made of a metal, and the supports 10 are made of a resin. However, the present invention is not necessarily limited thereto. The belt-shaped body 9 and the supports 10 may be integrally formed from a metal by press-forming a single metal sheet. Alternatively, the belt-shaped body 9 and the supports 10 may be integrally molded from a resin (or other members).

The support portions 10a and 10b each have an approximately triangular sectional configuration. Each oblique side of the triangular support portions forms a recess with an approximately quarter-circular arc shape. Thus, the approximately quarter-circular arc-shaped recesses of each pair of adjacent support portions cooperate with each other to form an optical fiber accommodating recess 10e with an approximately half-circular arc shape. It should be noted that the radius of the half-circular arc is, for example, 0.4 mm. In this embodiment, the feed holes 9b are used to feed the belt-shaped bodies 9 sequentially during the above-described injection molding process.

Accordingly, to assemble the optical fiber converging portion 3, as shown in FIG. 4, the lower portions of optical fibers 5 (with a radius, for example, of 0.375 mm) in the first tier including a plurality of columns are engagingly placed in the optical fiber accommodating recesses 10e of the upper support portions 10a of a belt-shaped spacer 8 for the first tier. Further, a belt-shaped spacer 8 for the second tier is placed above the optical fibers 5 arranged in a plurality of columns, and the optical fiber accommodating recesses 10e of the lower support portions 10b of the belt-shaped spacer 8 are engagingly placed over the optical fibers 5 in the first tier.

Subsequently, optical fibers 5 arranged in a plurality of columns in the second and later tiers and belt-shaped spacers 8 for the third and later tiers are successively and alternately stacked to ensure the required height. Thus, a large number of optical fibers 5 are arranged in a matrix of a plurality of tiers (rows) and a plurality of columns as a whole. In this case, the optical fibers 5 constituting the whole are stacked regularly in such a manner that the axes of the optical fibers 5 in the upper and lower adjacent tiers are present in the same vertical plane. However, because each optical fiber 5 is restrainedly supported so as not to be displaced sidewardly by engagement with the optical fiber accommodating recesses 10e of the supports 10 of the belt-shaped spacers 8, there is no possibility of the optical fibers 5 being displaced as in the regular stacking structure of the prior art. Further, in this case, the optical fibers 5 and the belt-shaped spacers 8 (supports 10) regulate each other's position. Therefore, other positioning members are not particularly needed. Accordingly, the number of required components can be reduced. Moreover, because each optical fiber 5 is supported by the supports 10 at the front and rear end portions of the belt-shaped spacers 8 as viewed in FIG. 5, the optical fibers 5 can extend straight in their longitudinal direction without curving sidewardly. In this regard also, the influence of the displacement between a pair of adjacent optical fibers can be prevented. It should be noted that, in FIG. 4, the gap between the outer periphery of each optical fiber 5 and the associated optical fiber accommodating recess 10e is shown as a larger gap than the actual size with a view to facilitating understanding.

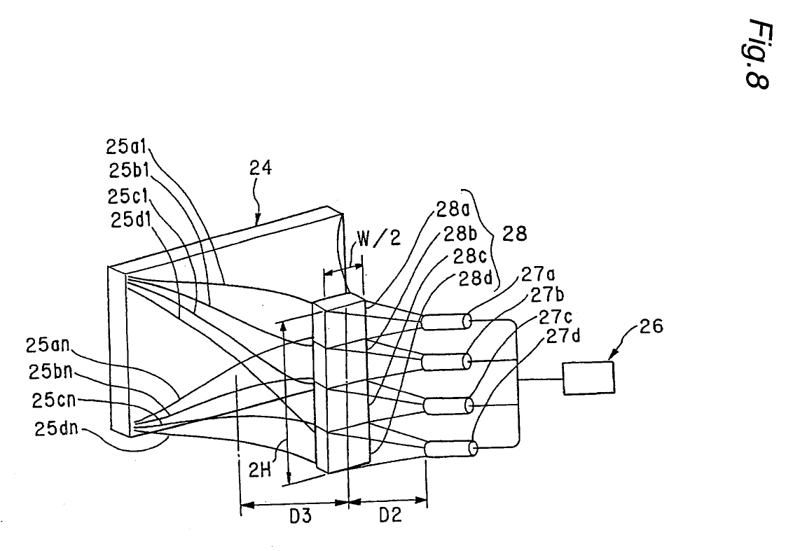

Next, another invention of this application will be described with reference to FIGS. 7 and 8. FIG. 7 shows a prior art example of the invention of this application. In the figure, an optical fiber display system 21 comprises roughly a projector 22 using, for example, a metal halide lamp, an optical fiber converging portion 23, a screen panel 24, and a large number of optical fibers 25 connecting the converging portion 23 and the screen panel 24 to each other. That is, a video signal from a video player unit 26 is sent to the projector 22. An image from the projector 22 is projected on the optical fiber converging portion 23. The image projected on the optical fiber converging portion 23 is guided to the screen panel 24 through the large number of optical fibers 25 stretched between the optical fiber converging portion 23 and the screen panel 24 in a plurality of tiers (rows) and a plurality of columns. Consequently, light is emitted from the optical fiber output ends on the front side of the screen panel 24 to display the desired image.

Let us assume that the width of the optical fiber converging portion 23 is W, and the height thereof is H (that is, the overall light-receiving area of the optical fiber converging portion 23 is WH), and further the distance between the projector 22 and the optical fiber converging portion 23 is D1. In this case, because the distance between the projector 22 and the optical fiber converging portion 23 is generally 1.5 times the width of the optical fiber converging portion 23, the distance D1≈1.5W. The projector 22 is relatively large in scale because it is necessary to illuminate the whole screen panel 24 at a desired illuminance with a single projector. As an actual example, the projector 22 using a metal halide lamp consumes a relatively large electric power, i.e. 3,000 watts, to obtain a desired illuminance of 12,000 ANSI lumen, for example. It should be noted that the term “ANSI” means that the illuminance was measured by the measuring method set by American National Standards Institute (Standard Document Number: ANSI/NAPM IT7.228-1997).

FIG. 8 shows another invention of this applications. In the figure, the same portions as those in FIG. 7 are denoted by the same reference symbols. In the prior art shown in FIG. 7, the system has a single projector and a single optical fiber converging portion. In the present invention, the system is provided with four projectors 27a to 27d, each using a halogen lamp, and a single optical fiber converging portion 28 comprising four optical fiber converging units 28a to 28d connected to each other. The optical fiber converging units 28a to 28d are provided with suffixes corresponding to the projectors 27a to 27d, respectively. It should be noted that lamps other than halogen lamps are also usable, e.g. xenon lamps, metal halide lamps, UHP lamps (Ultra High Power lamps produced by Philips), or UHE lamps (Ultra High Power lamps, i.e., high pressure mercury lamps, produced by Epson).

In this case, n tiers (n>1) of optical fibers 25 are converged into the uppermost optical fiber converging unit 28a. Of the optical fibers 25, the uppermost optical fiber row 25a1 is connected to the uppermost tier of the screen panel 24, and the lowermost optical fiber row 25an is connected to the fourth tier from the bottom of the screen panel 24. Optical fiber rows 25a2 . . . 25a(n−1) (not shown) between the uppermost and lowermost optical fiber rows 25a1 and 25an are connected to intermediate tiers between the uppermost tier and the fourth tier from the bottom of the screen panel 24 in order from the upper side toward the lower side so that the optical fiber rows 25a1 . . . 25an are positioned at equal pitches. Similarly, n tiers (n>1) of optical fibers 25b1 . . . 25bn converged into the second optical fiber converging unit 28b from the top are successively connected to respective tiers of the screen panel 24, i.e. those from the second tier from the top to the third tier from the bottom. Similarly, n tiers (n>1) of optical fibers 25c1 . . . 25cn converged into the third optical fiber converging unit 28c are connected to respective tiers of the screen panel 24, i.e. those from the third tier from the top to the second tier from the bottom, and n tiers (n>1) of optical fibers 25d1 . . . 25dn converged into the lowermost optical fiber converging unit 28d are connected to respective tiers of the screen panel 24, i.e. those from the fourth tier from the top to the lowermost tier. In other words, each of the optical fiber converging units 28a to 28d displays one complete image, but does not display a quarter of the complete image as split into four parts. In this case, the optical fibers 25 in each group of four tiers display the same image signal on the screen panel 24. However, because the size of the screen panel 24 is considerably large, the displayed image on the screen panel 24 as viewed in its entirety can be observed as a favorable image. It should be noted that in the above-described example a total of four optical fibers of the same tier from the four optical fiber converging units 28a to 28d are arranged on the screen panel 24 so as to be successively adjacent to each other in the vertical direction. However, the present invention is not necessarily limited to the described arrangement. The four optical fibers may be successively adjacent to each other in the horizontal direction. Alternatively, the four optical fibers may be respectively disposed at four vertices (or apexes) of an approximately quadrangular configuration. It is essential only that the four optical fibers should be placed adjacent to each other. Thus, the optical fibers may be arranged in various forms.

The operation of the optical fiber display system is as follows. A video signal from the video player unit 26 is sent to each of the projectors 27a to 27d. An image from the uppermost projector 27a, for example, is projected only on the uppermost optical fiber converging unit 28a. Thus, a complete image from the optical fiber converging unit 28a is displayed on the whole screen panel 24. Similarly, images from the other projectors 27b to 27d are projected on the corresponding optical fiber converging units 28b to 28d. A complete image from each of the optical fiber converging units 28b to 28d is displayed on the whole screen panel 24. Thus, the four complete images are superimposed on one another on the screen panel 24. Consequently, the luminance of the superimposed images is four times as high as the luminance of the image displayed by only each individual optical fiber converging unit 28a to 28d. Therefore, it is only necessary for each individual projector 27a to 27d to illuminate the screen panel 24 at an illuminance that is ¼ of the above-described desired illuminance in the system shown in FIG. 7. Accordingly, the projectors 27a to 27d may be relatively small in scale to obtain the required luminance. Thus, to obtain the same luminance as that in the prior art shown in FIG. 7, i.e. 12,000 ANSI lumen, the luminance required for each individual projector 27a to 27d is only 12,000 ANSI lumen÷4=3,000 ANSI lumen. The electric power consumed by a projector to provide 3,000 ANSI lumen is only 300 watts. Accordingly, the total power consumption is 300 watts×4=1,200 watts. Thus, the power consumption can be reduced much more than the prior art in FIG. 7, in which the power consumption is 3,000 watts.

Further, the width of each of the optical fiber converging units 28a to 28d is W/2, and the height thereof is H/2 (that is, the overall width of the optical fiber converging portion 28 is W/2, and the overall height thereof is 2H; the overall light-receiving area is the same as in the case of FIG. 8, i.e. WH). Assuming that the distance between the projector 27 and the optical fiber converging portion 28 is D2, D2=1.5×W/2≈0.75W because the distance D2 is generally 1.5 times the width of the optical fiber converging portion, as has been stated above. Hence, D2=(D1)/2. Therefore, the distance between the projector and the optical fiber converging portion can be reduced to approximately ½ of that in the arrangement shown in FIG. 7. Accordingly, the part of dimension D2 (in FIG. 8) of the optical fiber display system 21 can be reduced in size to approximately half of that in the prior art. Thus, it is possible to reduce the size of the whole system including the system 21, the optical fiber converging portion 28 and the projectors 27a to 27d (the whole system is transported as a completed unit). It should be noted that, in the completed unit, the distance D3 between the optical fiber converging portion 28 and the screen panel 24 can be reduced to as close to zero as possible by folding the optical fibers 25 (this is the same as for the arrangement shown in FIG. 7). Moreover, the system can be operated with the optical fibers 25 left folded to perform image display on the screen panel 24. This contributes to a further reduction in the overall size of the system. Further, because the four optical fiber converging units 28a to 28d are each in charge of displaying a complete image, even if one projector breaks down, for example, the complete image can still be displayed continuously by the remaining three projectors, although the image becomes somewhat dark as a whole.

1. An optical fiber positioning element (8) of an optical fiber converging portion (3) for converging a large number of optical fibers (5) led to a screen panel (4) for image display in an optical fiber display system,
said optical fiber positioning element (8) comprising a belt-shaped body (9) and a plurality of optical fiber supports (10) provided on upper and lower sides of said belt-shaped body (9) at a predetermined pitch in a longitudinal direction of said belt-shaped body,
wherein said large number of optical fibers (5) are supported by engagement with a plurality of optical fiber supports (10) on the upper and lower sides of said belt-shaped body (9).

2. An optical fiber positioning element according to claim 1, wherein said plurality of optical fiber supports (10) form accommodating recesses (10e) for engagingly accommodating optical fibers (5) between each pair of adjacent supports among a plurality of supports (10) integrally formed on said belt-shaped body (9) at a predetermined pitch in the longitudinal direction of said belt-shaped body.

3. An optical fiber positioning element according to claim 1 or 2, wherein said plurality of supports (10) are separate from each other.

4. An optical fiber positioning element according to claim 1 or 2, wherein said plurality of supports (10) are integral with each other.

5. An optical fiber positioning element according to any of claims 1 to 4, wherein said plurality of supports (10) are provided on both sides in the longitudinal direction of said belt-shaped body (9).

6. An optical fiber positioning element according to any of claims 1 to 5, wherein said belt-shaped body (9) is a metal sheet, and said supports (10) are integrally formed on said metal sheet from a resin by injection molding process.

7. An optical fiber positioning element according to claim 6, wherein said metal sheet (9) has a plurality of through-holes (9a) provided at a predetermined pitch in a longitudinal direction thereof, and said resin supports (10) extend through the through-holes of said metal sheet to form upper support portions (10a) and lower support portions (10b) on both sides of said metal sheet, said upper support portions (10a) and lower support portions (10b) being integral with each other, respectively, wherein said upper support portions form upper accommodating recesses (10e) for accommodating optical fibers (5) in a tier above said metal sheet, and said lower support portions form lower accommodating recesses (10e) for accommodating optical fibers in a tier below said metal sheet.

8. In a method of producing an optical fiber positioning element (8) of an optical fiber converging portion (3) for converging a large number of optical fibers (5) led to a screen panel (4) for image display in an optical fiber display system,
an optical fiber converging unit producing method comprising the steps of:
providing a belt-shaped body (9); and
forming a plurality of optical fiber supports (10) integrally with said belt-shaped body (9) on upper and lower sides of said belt-shaped body at a predetermined pitch in a longitudinal direction of said belt-shaped body.

9. An optical fiber converging unit producing method according to claim 8, wherein said belt-shaped body (9) is a metal sheet (9) having a plurality of through-holes (9a) provided at a predetermined pitch in a longitudinal direction thereof, and
wherein said plurality of optical fiber engagement members (10) are injection-molded from a resin so as to extend through the through-holes (9a) of said metal sheet to form upper support portions (10a) and lower support portions (10b) on both sides of said metal sheet, said upper support portions (10a) and lower support portions (10b) being integral with each other, respectively, wherein said upper support portions (10a) form upper accommodating recesses (10e) for engagingly accommodating optical fibers (5) in a tier above said metal sheet, and said lower support portions (10b) form lower accommodating recesses (10e) for engagingly accommodating optical fibers (5) in a tier below said metal sheet.

10. An optical fiber converging portion (3) for use in an optical fiber display system to converge a large number of optical fibers (5) led to a screen panel (4) for image display, said optical fiber converging portion (3) comprising:
a plurality of tiers of optical fiber positioning elements (8); and
a plurality of tiers of optical fibers (5), each tier having a plurality of columns of optical fibers (5);
said tiers of optical fiber positioning elements (8) and said tiers of optical fibers (5) being alternately stacked;
wherein said optical fiber positioning elements (8) each comprise a belt-shaped body (9) and a plurality of optical fiber supports (10) provided on upper and lower sides of said belt-shaped body (9) at a predetermined pitch in a longitudinal direction of said belt-shaped body, and
wherein said plurality of columns of optical fibers (5) in each tier are placed in engagement with optical fiber accommodating recesses (10e) of a plurality of optical fiber supports (10) on the upper and lower sides of said belt-shaped body (9).

11. In an optical fiber display system (21) wherein an image projected onto an optical fiber converging portion from a projector is guided to a screen panel (24) through a large number of optical fibers (25) converged at the optical fiber converging portion to display the image on said screen panel (24),
wherein there are provided a plurality of said projectors (27a to 27d),
said optical fiber converging portion (28) comprising a plurality of converging units (28a to 28d) connected to each other,
wherein images projected onto said plurality of converging units (28a to 28d) from said plurality of projectors (27a to 27d) individually are superimposed on one another on said screen panel (24) so as to be displayed as a single image.

12. In the optical fiber display system of claim 11, wherein the optical fiber converging portion is achieved by assembling said plurality of converging units (28a to 28d) together by connecting to each other vertically or horizontally in one vertical plane.
